(19) United States
(12) Patent Application Publication
(10) Pub. No.: US 2007/0166571 A1
(43) Pub. Date: Jul. 19, 2007

(54) Magnetic recording medium and process of production thereof

(75) Inventors: Katsuhiko Meguro, Odawara-shi (JP); Masatoshi Takahashi, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/649,792

(22) Filed: Jan. 5, 2007

(30) Foreign Application Priority Data
Jan. 16, 2006 (JP) 2006-007772

(51) Int. Cl. G11B 5/716; G11B 5/706

(52) U.S. Cl. 428/840; 428/847; 427/127

(57) ABSTRACT

An aspect of the present invention provides a magnetic recording medium comprising following layers in this order on at least one surface of a nonmagnetic support: a nonmagnetic layer including a nonmagnetic powder and a binder; and a magnetic layer including a magnetic powder and a binder, wherein the nonmagnetic support has an enthalpy relaxation (ΔH) equal to or more than 0.5 J/g and equal to or less than 2.0 J/g. According to the aspect of the present invention, a magnetic recording medium is provided that is superior in electromagnetic conversion (e.g., with a high S/N ratio for surface recording density) and running durability (e.g., with a small number of dropouts and a low error rate).

### BACKGROUND OF THE INVENTION

1. Field of the Invention

The present invention relates to a magnetic recording medium comprising a non-magnetic support having a non-magnetic layer and a magnetic layer in this order at least on a surface thereof, and a process of production thereof, particularly, the magnetic recording medium having both a superior electromagnetic conversion characteristic and a superior running durability, and a process of production thereof.

2. Description of the Related Art

Recently, in the field of magnetic tapes, magnetic recording media for recording computer data used as external memory media have been actively investigated with the widespread use of personal computers, workstations and the like. In the commercialization of magnetic recording media in this application, they are strongly required to have a larger storage capacity in order to respond to recording equipment with a larger capacity and a smaller size as well as computers with a smaller size and a higher data processing capacity.

Therefore, reproducing heads utilizing magnetic resistance (MR) as principle of operation have been recommended and are being applied to hard discs and the like, while application thereof to magnetic tapes is under consideration (see Japanese Patent Application Laid-Open No. 8-227517, for example). Since MR heads have several fold higher reproduction output than induction-type magnetic heads and do not use induction coil, equipment noise such as impedance noise is greatly decreased. Additional reduction of noise from magnetic recording media has enabled MR heads to have a large S/N ratio. In other words, it indicates that if noise from magnetic recording media is lower that has been obscured by equipment noise up to now, satisfactory record reproduction can be attained and thus the high density recording characteristic can be improved dramatically.

In conventional magnetic recording media, a magnetic layer having a powder of iron oxide, Co modified iron oxide, CrO₂ or a ferromagnetic hexagonal ferrite dispersed in a binder is widely used in the form of a coating on a nonmagnetic support. Of the magnetic powders, powders of ferromagnetic metals and ferromagnetic hexagonal ferrites are known to have a superior property of high density recording. In such a ferromagnetic powder, a decreased particle size is effective to reduce noise due to the magnetic recording media.

In order to provide magnetic recording media with a higher recording density and a higher recording capacity, a track width in recording therein and reproducing therefrom is becoming narrower. In addition, in the field of magnetic tapes, thinning of magnetic tapes allowing a higher density recording is under progress and thus many types of magnetic tape with a total thickness of 10 μm or less have come on the scene. However, as magnetic recording media become thinner, they become more susceptible to temperature and humidity during storage or operation, varying tension or the like.

Specifically, in recording and reproduction by a magnetic recording and reproducing system employing a linear recording mode, where the magnetic head must shift in the direction of the width of the magnetic tape to select any one of the tracks, a narrower track width requires a higher precision to control the position of the head relative to the tape. Even if a combined use of an MR head and a fine magnetic powder, as described above, allow a higher S/N ratio and a narrower width of tracks, the magnetic recording medium may be deformed by the ambient temperature and humidity during its operation and/or its varying tension in the drive, resulting in the inability of the reproducing head to read a recorded track. Therefore, the recording medium must be more dimensionally stable than conventional media. Such magnetic high density recording media are required to be even more dimensionally stable and mechanically stronger than the conventional media to maintain stable recording and reproduction.

In attempts to satisfy the requirement for dimensional stability and mechanically strength, it is recommended that a nonmagnetic support should undergo a specific heat treatment to decrease heat absorption to or below a certain value that results from enthalpy relaxation occurring in the amorphous region thereof (see Japanese Patent Application Laid-Open No. 11-110735, for example). This recommendation is directed to magnetic recording media with a higher durability, especially higher cyclic environmental characteristics.

### SUMMARY OF THE INVENTION

The foregoing Japanese Patent Application Laid-Open No. 8-227517 describes that delamination or the like of the members of magnetic recording media due to deformation such as heat shrinkage, which takes place in the members when the media are stored in a severe environment such as a cyclic environment between higher and lower temperatures, can be prevented by increasing heat absorption to or above 0.15 J/g that results from enthalpy relaxation of the amorphous chain region thereof. In a specification of the above-identified Japanese patent application, the upper limit of heat absorption is not particularly limited, but is set at about 0.6 J/g since the heat absorption reaches saturation, and the Example presents a case where the highest heat absorption is 0.4 J/g. Although these levels of heat absorption can be expected to prevent the delamination or the like in the cyclic environment, they cannot meet the dimensional stability requirement of high recording density media used in backup tapes for recent computers. Furthermore, the ferromagnetic metal powder used in the magnetic layer in the Example which has an average axial length of 0.07 μm cannot meet the S/N ratio requirement of high recording density media used in backup tapes for recent computers. Therefore, those described in the Japanese Patent Application Laid-Open No. 8-227517 may not solve the problems facing the current magnetic recording media.

The object of the present invention is to provide a magnetic recording medium superior in electromagnetic conversion (e.g., with a high S/N ratio for surface recording density) and running durability (e.g., with a small number of dropouts and a low error rate) and a process of production thereof.

To solve the above problems, in a magnetic recording medium having at least a nonmagnetic layer and a magnetic layer in this order on a nonmagnetic support, the present inventors have closely investigated enthalpy relaxation of the nonmagnetic support in order to improve the dimensional stability of the nonmagnetic support. As a result, they have completed the magnetic recording medium of the present invention with a low error rate and a high reliability.

In order to achieve the above object, a first aspect of the present invention provides a magnetic recording medium comprising following layers in this order on at least one surface of a nonmagnetic support: a nonmagnetic layer including a nonmagnetic powder and a binder; and a magnetic layer including a magnetic powder and a binder, wherein the nonmagnetic support has an enthalpy relaxation level (ΔH) equal to or more than 0.5 J/g and equal to or less than 2.0 J/g. According to the first aspect, a magnetic recording medium is provided that is superior in electromagnetic conversion (e.g., with a high S/N ratio for surface recording density) and running durability (e.g., with a small number of dropouts and a low error rate).

In a second aspect of the present invention, the magnetic powder is preferably a ferromagnetic hexagonal ferrite powder having an average plate size equal to or more than 5 nm and equal to or less than 40 nm, or a fine ferromagnetic metal powder having an axial length as average length equal to or more than 20 nm and equal to or less than 60 nm. According to the second aspect, a ferromagnetic hexagonal ferrite powder having a plate size equal to or less than 40 nm, or a fine ferromagnetic metal powder having an average long axial length equal to or more than 60 nm can be used to reduce noise from the magnetic recording medium.

In order to attain the above object, a third aspect of the present invention provides a method of producing a magnetic recording medium having a nonmagnetic layer including a nonmagnetic powder and a binder and a magnetic layer including a magnetic powder and a binder in this order on at least one surface of a nonmagnetic support, the method comprising: a thermal relaxation step of allowing the nonmagnetic support to have an enthalpy relaxation level (ΔH) equal to or more than 0.5 J/g and equal to or less than 2.0 J/g. According to the third aspect, the resultant magnetic recording medium is superior in electromagnetic conversion (e.g., with a high S/N ratio for surface recording density) and running durability (e.g., with a small number of dropouts and a low error rate).

In a fourth aspect of the present invention, the magnetic powder used here is preferably a ferromagnetic hexagonal ferrite powder having an average plate size equal to or more than 5 nm and equal to or less than 40 nm, or a fine ferromagnetic metal powder having an axial length as average length equal to or more than 20 nm and equal to or less than 60 nm. According to the fourth aspect, a fine ferromagnetic hexagonal ferrite powder having a plate size equal to or less than 40 nm, or a fine ferromagnetic metal powder having an average long axial length equal to or more than 60 nm can be used to reduce noise from the magnetic recording medium.

In a fifth aspect of the present invention, in the thermal relaxation step, the nonmagnetic support is preferably kept in a temperature range equal to or more than Tg (° C.) −40° C. and equal to or less than Tg (° C.) −1° C., and wherein the Tg (° C.) represents the glass transition temperature of a resin forming the nonmagnetic support.

In a sixth aspect of the present invention, the thermal relaxation step preferably has a period of time equal to or more than 1 hour and equal to or less than 14 days.

In a seventh aspect of the present invention, the thermal relaxation step is preferably carried out before at least one of the nonmagnetic layer and the magnetic layer is formed.

In an eighth aspect of the present invention, the nonmagnetic support is preferably formed of biaxially oriented polyethylene terephthalate or biaxially oriented polyethylene naphthalate as main component.

The present invention established in this way has a more pronounced effect than conventional methods (e.g., the Japanese Patent Application Laid-Open No. 8-227517 and the like), since the invention provides a magnetic recording medium superior in electromagnetic conversion (e.g., with a high S/N ratio for surface recording density) and running durability (e.g., with a small number of dropouts and a low error rate).

### BRIEF DESCRIPTION OF THE DRAWINGS

FIG. 1 shows a production process diagram to describe a method of producing the magnetic recording medium according to the present invention; and

FIG. 2 shows a schematic sectional view of the magnetic recording medium according to the present invention.

### DETAILED DESCRIPTION OF THE PREFERRED EMBODIMENTS

The magnetic recording medium according to the present invention and a process of production thereof will be described below in more detail.

### I. Nonmagnetic Support

Examples of the nonmagnetic support available in the present invention may include known biaxially oriented polymers such as polyethylene naphthalate, polyethylene terephthalate, polyamides, polyimides, polyamideimides, aromatic polyamides, and polybenzoxazole. Polyethylene terephthalate (PET) or polyethylene naphthalate (PEN) is preferable. The nonmagnetic supports may be previously treated by corona discharge, plasma, a procedure making it more adhesible, heat or the like.

A method of preparing the nonmagnetic support of the present invention is not limited in particular, but preferably includes regulation of mechanical strengths both in the longitudinal direction and in the width direction. Specifically, the resin described above is formed into film (film formation), which is then preferably drawn both in the longitudinal direction and in the width direction at suitable degrees. The support used in the present invention has Young's moduli of 4.4 to 15 GPa both in the longitudinal direction and in the width direction, preferably 5.5 to 11 GPa, and the Young's moduli in the longitudinal direction and in the width direction may be different from each other. To regulate mechanical strengths both in the longitudinal direction and in the width direction, the undrawn film is drawn biaxially for biaxial orientation. The drawing method used here may be either stepwise biaxial drawing or concurrent biaxial drawing. When the stepwise biaxial drawing is carried out involving the first drawing in the longitudinal direction and the second drawing in the width direction, the drawing in the longitudinal direction is carried out, as a preferable example, in at least three steps in the respective ranges of the longitudinal drawing temperature from 80° C. to 180° C., the total longitudinal drawing ratio from 3.0 to 6.0, and the longitudinal drawing rate from 5,000%/min to 50,000%/min. The drawing in the width direction is preferably carried out using a tenter, preferably in the respective ranges of the drawing temperature from the glass transition temperature (Tg) of the film to Tg+100° C., the widthwise drawing ratio from 3.2 to 7.0 which may be optionally larger than the longitudinal ratio, and the widthwise drawing rate from 1,000%/min to 20,000%/min. In addition, it may be drawn again in the longitudinal direction and/or in the width direction. Since the drawing conditions such as drawing ratio and drawing temperature greatly affects the molecular orientation, the conditions must be set properly to provide a biaxially oriented film which is the nonmagnetic support of the invention.

Next, the biaxially oriented film is treated by heat. It is preferably treated by heat in the respective ranges of temperature from the cooling crystallization point (Tc)+40 to Tc+100° C. and a period of time from 0.5 sec to 60 sec. Since the heat treatment conditions, and the process temperature conditions until it is cooled to ambient temperature and the like may change the glass transition temperature and/or heat shrinkage, the conditions must be also set properly to provide the biaxially oriented film of the invention.

A magnetic recording medium superior in electromagnetic conversion and running durability can be produced by such heat treatment of the biaxially oriented film under proper heat treatment conditions to cause enthalpy relaxation in the nonmagnetic support. The heat treatment temperature is lower by 1° C. to 40° C. than the glass transition temperature (Tg) of the material for the biaxially oriented film, preferably by 1° C. to 30° C., more preferably by 1° C. to 20° C. If the heat treatment temperature is lower by more than 40° C. than the glass transition temperature of the material for the biaxially oriented film, too long a time of heat treatment is necessary, and on the other hand, if the heat treatment temperature is higher than the glass transition temperature, the enthalpy relaxation becomes insufficient due to too great a micro Brownian movement of the polymer backbone.

The specific temperature of the heat treatment varies depending on the material for forming the biaxially oriented film. The time of the heat treatment is 1 hour to 14 days, preferably 5 hours to 7 days, and more preferably 10 hours to 50 hours. If the time of heat treatment is less than 1 hour, a stable effect of heat treatment is not developed, while if it is longer than 14 days, the effect of heat treatment is comparable to that at a shorter time, but the longer time is unfavorable in terms of production efficiency. It should be noted that it is more preferably cooled slowly to room temperature after the heat treatment.

The method of heat treatment is not limited in particular, and the biaxially oriented film may be heat-treated in any state of an unrolled film, a rolled film and a combination thereof.

The heat treatment causes heat absorption (hereinafter, referred to as enthalpy relaxation level (ΔH)) of the biaxially oriented film due to enthalpy relaxation occurring in the amorphous region thereof, which is preferably equal to or more than 0.5 J/g and equal to or less than 2.0 J/g, more preferably equal to or more than 0.55 J/g and equal to or less than 1.9 J/g, and most preferably equal to or more than 0.6 J/g and equal to or less than 1.8 J/g. The present invention is characterized by the enthalpy relaxation level (ΔH) equal to or more than 0.5 J/g and equal to or less than 2.0 J/g, which is different from the level given by the method described in the Japanese Patent Application Laid-Open No. 8-227517.

The enthalpy relaxation originating in the amorphous region takes place for the following reasons and the like. Specifically, the amorphous region of the polymer material or the like, which forms the biaxially oriented film as nonmagnetic support, is in a liquid state at or above the glass transition temperature. When this material in the liquid state of the amorphous region is rapidly cooled, its enthalpy decreases keeping the equilibrium state until it reaches the glass transition temperature. Once the temperature of the material lowers below the glass transition temperature, the amorphous region that has been in a liquid state undergoes phase change to increase its viscosity sharply. Then, segments constituting the amorphous region of the polymer material or the like become less mobile. As a result, the decrease of enthalpy in the amorphous region cannot follow the temperature depression caused by cooling, and the amorphous region changes in the state of disequilibrium. In this way, the polymer material or the like rapidly cooled at or below the glass transition temperature falls into disequilibrium and therefore should have an excessive enthalpy compared with that at equilibrium. Thereafter, in the material having the excessive enthalpy, the amorphous region changes slowly from the disequilibrium state to the glass state at equilibrium to release the excessive enthalpy.

The present invention provides a faster stabilization of the material by heat treatment under the foregoing conditions to facilitate transformation from the liquid state to the glass state at equilibrium. The material in the resultant state is then heated slowly from a temperature below the glass transition temperature to the glass transition temperature, at which the material, such as the polymer material, absorbs heat due to enthalpy relaxation occurring in the amorphous region and causes the phase change of the amorphous region from the glass state at equilibrium to the liquid state.

As is clear in the foregoing description, the enthalpy relaxation is correlated to the decreased level of enthalpy caused by transformation from the disequilibrium state of the amorphous region to the equilibrium state, and also to the extent of the heat treatment, and as the extent of the heat treatment is greater, the enthalpy relaxation (ΔH) is larger.

The conditions of heat treatment for providing the enthalpy relaxation (ΔH) equal to or more than 0.5 J/g and equal to or less than 2.0 J/g are given by the ranges of temperature and time described above. According to the close investigation made by the inventors, the enthalpy relaxation (ΔH) with a value less than 0.5 J/g has been found to place the biaxially oriented film at a larger degree of equilibrium in glass state and make it dimensionally less stable to such an extent that it cannot be used as nonmagnetic support for magnetic recording media. Furthermore, more than 2.0 J/g of enthalpy relaxation (ΔH) has been also found to cause the problems of reducing the orientation of the film once enhanced by drawing and the like. The lower limit of the enthalpy relaxation (ΔH) has a value equal to or more than 0.5 J/g, preferably 0.6 J/g. The upper limit thereof is not particularly limited, but practically 2.0 J/g, preferably about 1.8 J/g, since a long heat treatment causes deformation or the like of the biaxially oriented film.

In the nonmagnetic support available in the present invention, the magnetic layer coated thereon has a coating-side surface with a center surface average roughness (JIS B 0660-1998, ISO 4287-1997) equal to or more than 1.8 nm and equal to or less than 9 nm, and preferably equal to or more than 2 nm and equal to or less than 8 nm, if the layer is cut off at 0.25 mm. Both surfaces of the support may have different roughnesses. The nonmagnetic support in the magnetic recording medium of the present invention has preferably a thickness equal to or more than 3 μm and equal to or less than 60 μm.

### II. Magnetic Materials

### <Ferromagnetic Metal Powder (Fine Ferromagnetic Metal Powder>

The ferromagnetic metal powder (i.e. fine ferromagnetic metal powder) used in the magnetic layer of the inventive magnetic recording medium is known to be superior in high density recording and thus it can provide magnetic recording media superior in electromagnetic conversion. The ferromagnetic metal powder used in the magnetic layer of the inventive magnetic recording medium has an axial length as average length (hereinafter, referred to as average long axial length) equal to or more than 20 nm and equal to or less than 60 nm, preferably equal to or more than 25 nm and equal to or less than 50 nm, and more preferably equal to or more than 30 nm and equal to or less than 45 nm. As long as the ferromagnetic metal powder has an average long axial length equal to or more than 20 nm, its magnetic deterioration due to thermal fluctuation can be prevented effectively. As long as the ferromagnetic metal powder has an average long axial length equal to or less than 60 nm, a good S/N ratio can be attained keeping low noise.

The axial length as average length (average long axial length) of the ferromagnetic metal powder can be determined as the average of values measured both by a technique of taking a transmission electron micrograph of the ferromagnetic metal powder and directly reading the short and long axial lengths of the ferromagnetic metal powder on the micrograph and by another technique of tracing the transmission electron micrograph with an image analysis system, IBASSI by Karl Zeiss, to read them.

The ferromagnetic metal powder used in the magnetic layer of the inventive magnetic recording medium is not limited in particular if it contains Fe as major component, and it is preferably a ferromagnetic metal powder containing α-Fe as major component. In addition to the predetermined atom, the ferromagnetic powder may contain different atoms selected from Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. In addition to α-Fe, the ferromagnetic powder contains preferably at least one of Al, Si, Ca, Y, Ba, La, Nd, Co, Ni and B, and particularly preferably Co, Al and/or Y. More specifically, it preferably contains 10 to 40 atom % of Co, 2 to 20 atom % of Al, and 1 to 15 atom % of Y based on Fe.

The ferromagnetic metal powder may be pretreated with a dispersant, a lubricant, a surfactant, an antistatic agent and/or the like before it is dispersed. The ferromagnetic metal powder may a small amount of water, hydroxide or oxide. The ferromagnetic metal powder preferably has a water content of 0.01 to 2%. The water content of the ferromagnetic metal powder is preferably optimized depending on the type of a binder. The ferromagnetic metal powder is preferably set at an optimal pH depending on the combination thereof with a binder used. The pH is typically in a range of 6 to 12, preferably 7 to 11. The ferromagnetic powder occasionally may contain soluble inorganic ion species such as Na, Ca, Fe, Ni, Sr, NH₄, SO₄, Cl, NO₂, and NO₃. Preferably, they are essentially absent. The ferromagnetic powder is not affected for its properties by the ion species if the total ion content thereof is 300 ppm or less. The ferromagnetic powder used in the invention preferably has a smaller volume of pores equal to or less than 20 vol %, and preferably equal to or less than 5 vol %.

The crystallite of the ferromagnetic metal powder has a size equal to or more than 8 nm and equal to or less than 20, preferably equal to or more than 10 nm and equal to or less than 18, and more preferably equal to or more than 12 nm and equal to or less than 16. The crystallite size is an average value determined by the Scherrer method from the half width of the diffraction peak, which was measured by an X ray diffractometer (a RINT 2000 series from Rigaku Denki) under the conditions of CuKα1 as radiation source, 50 kV of tube voltage, and 300 mA of tube current.

The ferromagnetic metal powder preferably has a specific surface (S_{BET}) based on the BET method which is equal to or more than 30 m²/g and less than 50 m²/g, and more preferably equal to or more than 38 m²/g and equal to or less than 48 m²/g. As long as the specific surface is within this range, the resultant magnetic recording medium can have a satisfactory surface property as well as low noise. The ferromagnetic metal powder is preferably set at an optimal pH depending on the combination thereof with a binder used. The pH is in a range of 4 to 12, preferably 7 to 10. The ferromagnetic metal powder may optionally undergo surface treatment with Al, Si and/or P, or an oxide thereof or the like. The amount thereof is 0.1% to 10% based on the ferromagnetic metal powder. The surface treatment is preferable since a lubricant such as fatty acid is adsorbed at a decreased level of 100 mg/m² or less. The ferromagnetic powder occasionally contains soluble inorganic ion species such as Na, Ca, Fe, Ni, and Sr, but it is affected only slightly for its properties by the ion species if the ion content is 200 ppm or less. The ferromagnetic powder used in the invention preferably has a smaller volume of pores equal to or less than 20 vol %, and preferably equal to or less than 5 vol %.

The ferromagnetic metal powder may be of any shape of needles, granules, rice grains or plates, if it meets the particle size property described above. The needle form of ferromagnetic powder is particularly suitable to use. The needle form of ferromagnetic metal powder preferably has a length-to-width ratio of 4 to 12, more preferably 5 to 12. The ferromagnetic metal powder preferably has Hc of 159.2 kA/m to 238.8 kA/m, more preferably 167.2 kA/m to 230.8 kA/m. Its saturated magnetic flux density is preferably 150 T·m to 300 T·m, more preferably 160 T·m to 290 T·m. Its as is preferably 140 A·m²/kg to 170 A·m²/kg, more preferably 145 A·m²/kg to 160 A·m²/kg.

The magnetic material itself preferably has a smaller SFD (switching field distribution), preferably 0.8 or less. When the SFD is 0.8 or less, the magnetic recording medium has a better electromagnetic conversion, a higher output, and a sharper magnetization reversal with a smaller peak shift, which are suitable for digital high density magnetic recording. A narrower Hc distribution of ferromagnetic metal powder can be attained by some approaches including: improvement in a size distribution of the goethite; use of monodisperse α-Fe₂O₃; and prevention of sintering between the particles.

The ferromagnetic metal powder used here can be prepared by known production methods as follows: treatment of hydrated iron oxide or iron oxide to prevent sintering, followed by reduction thereof with a reducing gas such as hydrogen to provide particles of Fe, Fe—Co or the like; reduction of a complex organic acid salt (predominantly, oxalate) with a reducing gas such as hydrogen; thermal decomposition of a metal carbonyl compound; reduction of a ferromagnetic metal salt by addition of a reducing agent such as sodium borohydride, a hypophosphite or hydrazine into its aqueous solution; evaporation of a metal in an inert gas under reduced pressure to prepare a fine powder; and the like. The resulting ferromagnetic metal powder is subjected to a known slow oxidation. It is preferable that hydrated iron oxide or iron oxide is reduced with a reducing gas such as hydrogen, and then slowly oxidized with a mixture of an oxygen-containing gas and an inert gas under regulated partial pressures while the temperature and the time are controlled to form an oxide skin on its surface, because it is demagnetized to a lesser extent.

### <Ferromagnetic Hexagonal Ferrite Powder>

The ferromagnetic hexagonal ferrite powder has a hexagonal magnetoplumbite structure with a very large uniaxial crystalline magnetic anisotropy as well as a very high coercive force (Hc). Therefore, magnetic recording media containing the ferromagnetic hexagonal ferrite powder are superior in chemical stability, corrosion resistance and abrasion resistance, and capable of decreasing magnetic spacing along with density increase and providing further a thin configuration, a high C/N and a high resolution. The ferromagnetic hexagonal ferrite powder preferably has an average plate size equal to or more than 5 nm and equal to or less than 40 nm, more preferably equal to or more than 10 nm and equal to or less than 38 nm, and most preferably equal to or more than 15 nm and equal to or less than 36 nm.

When a magnetic recording medium with a higher track density is reproduced with a magnetoresistive head, it is generally necessary that not only the medium makes a lower noise but also a ferromagnetic hexagonal ferrite powder to be used therein has a smaller average plate size. The hexagonal ferrite preferably has as small an average plate size as possible also in order to decrease the magnetic spacing. However, if the ferromagnetic hexagonal ferrite powder has too small an average plate size, its magnetization is destabilized due to thermal fluctuation. Consequently, the ferromagnetic hexagonal ferrite powder used in the magnetic layer of the inventive magnetic recording medium has an average plate size with a lower limit set at 5 nm. As long as the average plate size is 5 nm or more, it can be magnetized stably without any significant effect of thermal fluctuation. On the other hand, the ferromagnetic hexagonal ferrite powder has an average plate size with an upper limit of 40 nm. As long as the average plate size is 40 nm or less, a degraded electromagnetic conversion due to a higher noise can be avoided, which is especially appropriate for reproduction with a magnetoresistive (MR) head. The average plate size of the ferromagnetic hexagonal ferrite powder can be determined as the average of values measured both by a technique of taking a transmission electron micrograph of the ferromagnetic hexagonal ferrite powder and directly reading the plate size of the ferromagnetic hexagonal ferrite powder on the micrograph and by another technique of tracing the transmission electron micrograph with the image analysis system, IBASSI by Karl Zeiss, to read it.

The ferromagnetic hexagonal ferrite powder contained in the inventive magnetic layer includes substitutional forms, for example, barium ferrite, strontium ferrite, lead ferrite and calcium ferrite, and a Co substitutional form and the like. More specifically, it includes barium ferrite and strontium ferrite which are of magnetoplumbite type, magnetoplumbite-type ferrites having a particulate surface coated with spinet, and magnetoplumbite-type barium and strontium ferrites partially containing a spinel phase. In addition to the predetermined atoms, it may contain different atoms selected from Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Generally, it may incorporate elements selected from Co—Zn, Co—Ti, Co—Ti—Zr, Co—Ti—Zn, Ni—Ti—Zn, Nb—Zn—Co, Sb—Zn—Co, Nb—Zn and the like. Further, it may contain specific impurities derived from the raw materials and/or the production process.

The ferromagnetic hexagonal ferrite powder has a particle size represented by an average plate size of 5 nm to 40 nm, preferably 10 nm to 38 nm, and more preferably 15 nm to 36 nm, as described above. It has a plate thickness of 1 nm to 30 nm, preferably 2 nm to 25 nm, and more preferably 3 nm to 20 nm. It has a plate ratio (plate size/plate thickness) of 1 to 15, more preferably 1 to 7. As long as the plate ratio is 1 to 15, it can have a satisfactory orientation while the magnetic layer is filled therewith at a high level, and an increased noise due to stacking of the particles can be prevented. It has a specific surface based on the BET method of 10 to 200 m²/g when the particle size is within the above range. The specific surface roughly corresponds to the value of calculation given by the plate size and thickness.

Preferably, the ferromagnetic hexagonal ferrite powder typically has narrower distributions of the plate size and thickness, respectively. Digitization of the plate size and thickness is difficult, but they can be relatively determined by random choice and measurements of 500 particles in a TEM micrograph of the powder. The distributions of the plate size and thickness are mostly out of normal distribution, and calculation of the standard deviation relative to the average size gives: σ/average size=0.1-2.0. To make the particle size distribution sharper, the system for particle formation is made as homogeneous as possible and the resultant particles may be further processed to improve the distribution. For instance, discriminative dissolution of very fine particles among the particles in an acidic solution is one of such known processing methods.

The hexagonal ferrite particles may have Hc in the range of 159.2 kA/m to 238.8 kA/m, but preferably 175.1 kA/m to 222.9 kA/m, more preferably 183.1 kA/m to 214.9 kA/m. However, if the head has a saturation magnetization (σs) more than 1.4 T, the Hc is preferably 159.2 kA/m or less. The Hc can be controlled by particle sizes (plate size and plate thickness), types and amounts of component elements, substitution sites of the elements, reaction conditions for particle formation and the like.

The hexagonal ferrite particles have as of 40 to 80 A·m²/kg. A higher as is preferable, but a finer particle tends to have a lower cys. To improve as, formation of a composite of a magnetoplumbite ferrite with a spinel ferrite, selection of types and amounts of component elements, and the like are well known. In addition, a W-type hexagonal ferrite may be used. When the magnetic material is dispersed, the surface of the magnetic material may be treated with a dispersant and a material compatible with the polymer. The surface treatment agent used here may be an inorganic or organic compound. Representative examples of the compound include oxides or hydroxides of Si, Al, P and the like, various silane coupling agents, and various titanium coupling agents. The compound is added in an amount of 0.1 mass % to 10 mass % based on the magnetic material. The pH of the magnetic material is also a key factor to its dispersion. The pH is typically in the order of 4 to 12, though it has an optimum value depending on the dispersant and the polymer. A selected range of the pH is 6 to 11 in terms of chemical and storage stabilities of the medium. The water contained in the magnetic material also affects its dispersion. The water content has an optimum value depending on the dispersant and the polymer, but it is typically selected from 0.01% to 2.0%.

The process of producing a ferromagnetic hexagonal ferrite powder includes, but not limited to: a glass crystallization process which comprises mixing barium oxide, iron oxide, a metal oxide for substituting iron, boron oxide as glass former and the like so that the resulting mixture has a desired ferrite composition, melting the mixture, quenching the mixture to form an amorphous material, and heating once more the amorphous material, followed by washing and pulverization thereof to produce a crystalline barium ferrite powder; a hydrothermal reaction process which comprises neutralizing a solution of a metal salt having a barium ferrite composition with alkali, removing byproducts from the solution, and heating the solution as liquid phase at 100° C. or higher, followed by washing, drying and pulverization thereof to produce a crystalline barium ferrite powder; and a coprecipitation process which comprises neutralizing a solution of a metal salt having a barium ferrite composition with alkali, removing byproducts from the solution, drying the solution and heating the dried material at or below 1,100° C., followed by pulverization thereof to produce a crystalline barium ferrite powder. The ferromagnetic hexagonal ferrite powder may undergo surface treatment with Al, Si and/or P, or an oxide thereof or the like, if necessary. The amount thereof is 0.1% to 10% based on the ferromagnetic powder. The surface treatment is preferable since a lubricant such as fatty acid is adsorbed at a decreased level of 100 mg/m² or less. The ferromagnetic powder occasionally contains soluble inorganic ion species such as Na, Ca, Fe, Ni, and Sr. It is preferable that the ion species are essentially absent, but the powder is affected only slightly for its properties by the ion species if the ion content is 200 ppm or less.

III. Nonmagnetic Powder The magnetic recording medium according to the present invention has a nonmagnetic layer containing a binder and a nonmagnetic powder on a nonmagnetic support. The nonmagnetic powder available for the nonmagnetic layer may be an inorganic or organic substance. Carbon black or the like is also useful. The inorganic substance includes, for example, metals, metal oxides, metal carbonates, metal sulfates, metal nitrides, metal carbides and metal sulfides.

Specifically, it includes titanium oxides such as titanium dioxide, cerium oxide, tin oxide, tungsten oxide, ZnO, ZrO₂, SiO₂, Cr₂O₃, α-alumina with 90 to 100% of the α form, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide, which may be used alone or in combination of two or more species. Preferable species are α-iron oxide and titanium oxides.

The nonmagnetic powder may be of any shape of needles, spheres, polyhedrons or plates. The crystallite of the nonmagnetic powder preferably has a size of 4 nm to 1 μm, more preferably 40 nm to 100 nm. As long as the crystallite size is within a range of 4 nm to 1 μm, preferably, it is not difficult to disperse and has a suitable surface roughness. The nonmagnetic powder preferably has an average particle size of 5 nm to 2 μm, but a combination of nonmagnetic powders with different average particle sizes may be used, if necessary, or a single nonmagnetic powder with a broader particle size distribution may be used so as to exhibit a similar effect. Particularly preferably, the nonmagnetic powder has an average particle size of 10 nm to 200 nm. As long as the average particle size is within a range of 5 nm to 2 μm, preferably, it is good to disperse and has a suitable surface roughness.

The nonmagnetic powder has a specific surface of 1 m²/g to 100 m²/g, preferably 5 m²/g to 70 m²/g, and more preferably 10 m²/g to 65 m²/g. As long as the specific surface is within a range of 1 m²/g to 100 m²/g, preferably, the powder has a suitable surface roughness and can be dispersed with a desired amount of a binder. Its oil absorption level determined using dibutyl phthalate (DBP) is 5 mL/100 g to 100 mL/100 g, preferably 10 mL/100 g to 80 mL/100 g, and more preferably 20 mL/100 g to 60 mL/100 g. Its specific density is 1 to 12, preferably 3 to 6. Its tap density is 0.05 g/mL to 2 g/mL, preferably 0.2 g/mL to 1.5 g/mL. As long as the tap density is within a range of 0.05 g/mL to 2 g/mL, only a little amount of the powder flies away, resulting in its easy handling, and it also tends to be difficult in firmly adhering to the equipment. The pH of the nonmagnetic powder is preferably 2 to 11, particularly preferably 6 to 9. As long as the pH is in a range of 2 to 11, its friction coefficient is not increased either under the conditions of elevated temperature and humidity or by liberation of fatty acid. The nonmagnetic powder has a water content of 0.1 mass % to 5 mass %, preferably 0.2 mass % to 3 mass %, and more preferably 0.3 mass % to 1.5 mass %. As long as the water content is within a range of 0.1 mass % to 5 mass %, preferably, its dispersion is good and a coating obtained after the dispersion has a stable viscosity. Its loss on ignition is preferably 20 mass % or less, preferably in a lesser amount.

If the nonmagnetic powder is an inorganic powder, it preferably has a Mohs hardness of 4 to 10. As long as the Mohs hardness is within a range of 4 to 10, it remains endurable. The nonmagnetic powder has a stearic acid absorption of 1 μmol/m² to 20 μmol/m², more preferably 2 μmol/m² to 15 μmol/m². The nonmagnetic powder preferably has a heat of wetting in water at 25° C. preferably ranging from 200 erg/cm² to 600 erg/cm². A solvent can be used if the powder has a heat of wetting in that range in the solvent. The powder has water molecules on its surface at 100° C. to 400° C. appropriately ranging from 1 molecule/100 Å to 10 molecules/100 Å. Its isoelectric point in water preferably has a pH value of 3 to 9. The surface of the nonmagnetic powder is preferably treated with Al₂O₃, SiO₂, ZrO₂, TiO₂, SnO₂, Sb₂O₃, and/or ZnO. Of these, Al₂O₃, SiO₂, TiO₂, and ZrO₂ are preferable in terms of dispersibility, and Al₂O₃, SiO₂, and ZrO₂ are more preferable. These may be used in combination or alone. Furthermore, according to the purpose, the powder may be coated with a co-deposited surface treatment layer, or it may be first treated with alumina to form a surface layer, which may be then treated with silica, or a process carried out in its reverse order may be taken. The surface treatment layer may be a porous layer according to the purpose, but generally it is preferably a homogeneous, dense layer.

Specific examples of the nonmagnetic powder used in the inventive nonmagnetic layer include, for example, nanotites made by Showa Denko; HIT-100 and ZA-G1 made by Sumitomo Chemical; DPN-250, DPN-250BX, DPN-245, DPN-270BX, DPB-550BX and DPN-550RX made by Toda Kogyo; titanium oxides TTO-51B, TTO-55A, TTO-55B, TTO-55C, TTO-55S, TTO-55D, SN-100 and MJ-7, and α-iron oxide E270, E271 and E300 made by Ishihara Sangyo; STT-4D, STT-30D, STT-30 and STT-65C made by Titan Kogyo; and MT-100S, MT-100T, MT-150W, MT-500B, T-600B, T-100F and T-500HD made by Tayca. Also, they include FINEX-25, BF-1, BF-10, BF-20 and ST-M made by Sakai Chemical; DEFIC-Y and DEFIC-R made by Dowa Mining; AS2BM and T102P25 made by Nippon Aerosil; 100A and 500A made by Ube Industries; and Y-LOP and its sintered product made by Titan Kogyo. Particularly preferable nonmagnetic powders are titanium dioxide and a-iron oxide.

An organic powder may be added to the nonmagnetic layer according to the purpose. Examples of the organic powder may include acryl-styrene resin powders, benzoguanamine resin powders, melamine resin powders and phthalocyanine pigments, but also polyolefin resin powders, polyester resin powders, polyamide resin powders, polyimide resin powders and polyethylene fluoride resins.

### IV. Binder

The binder used in the inventive magnetic layer includes thermoplastic resins, thermoset resins, reactive resins and blends thereof which have been known. Thermoplastic resins may include polymers or copolymers containing component units such as vinyl chloride, vinyl acetate, vinyl alcohol, maleic acid, acrylic acid, acrylates, vinylidene chloride, acrylonitrile, methacrylic acid, methacrylates, styrene, butadiene, ethylene, vinyl butyral, vinyl acetal and vinyl ethers, and also polyurethane resins and various types of rubber-based resins.

Thermoset resins or reactive resins may include, for example, phenol resins, epoxy resins, thermoset polyurethane resins, urea resins, melamine resins, alkyd resins, acrylic reactive resins, formaldehyde resins, silicone resins, epoxy-polyamide resins, blends of polyester resins and isocyanate prepolymers, blends of polyester polyols and polyisocyanates and blends of polyurethanes and polyisocyanates. Thermoplastic resins, thermoset resins and reactive resins are described in detail in “Plastics Handbook” published in Japanese by Asakura Publishing Company.

Electron beam curing resins are used in the magnetic layer to not only enhance the coating strength and thus the durability, but also flatten the surface and thus improve electromagnetic conversion properties.

These resins may be used in a single or combined form. Of those resins, polyurethane resins are preferably used which are preferably selected from the following: polyurethane resins prepared by reacting a cyclic structure, such as hydrogenated bisphenol A or adduct of hydrogenated bisphenol A with polypropylene oxide, a polyol with an alkylene oxide chain(s) having a molecular weight of 500 to 5,000, and a chain-extender polyol with a cyclic structure having a molecular weight of 200 to 500 with an organic diisocyanate, and further incorporating hydrophilic polar groups; polyurethane resins prepared by reacting a polyester polyol, which is formed from an aliphatic diacid, such as succinic acid, adipic acid or sebacic acid, and an acyclic alkyl-branched aliphatic diol, such as 2,2-dimethyl-1,3-propanediol, 2-ethyl-2-butyl-1,3-propanediol, or 2,2-diethyl-1,3-propane diol and a chain-extender aliphatic diol with an alkyl branch(es) of three or more carbon atoms, such as 2-ethyl-2-butyl-1,3-propanediol or 2,2-diethyl-1,3-propanediol, with an organic diisocyanate, and further incorporating hydrophilic polar groups; and polyurethane resins prepared by reacting a cyclic structure such as dimer diol, and a polyol compound with a long alkyl chain(s) with an organic diisocyanate, and further incorporating hydrophilic polar groups.

The polar group-containing polyurethane resin used in the present invention preferably has an average molecular weight of 5,000 to 100,000, more preferably 10,000 to 50,000. As long as the average molecular weight is 5,000 or more, preferably, the coated layer therefrom is not physically weaker, for example, more brittle, and has no effect on the durability of the magnetic recording medium. As long as the average molecular weight is 100,000 or less, the polyurethane is not less soluble in a solvent, and thus it is well dispersible. In addition, its coating in a given concentration is not increased in viscosity, and therefore it is good to work and easy to handle.

The polar groups contained in the polyurethane resin, for example, include —COOM, —SO₃M, —OSO₃M, —P═O(OM)₂, —O—P═O(OM)₂ (M denotes a hydrogen atom or an alkali metal), —OH, —NR₂, —N═R₃ (R denotes a hydrocarbon group), an epoxy group, —SH, and —CN, where at least one of the polar groups is incorporated into the polyurethane resin by copolymerization or addition to make the resin suitable for use. If the polar group-containing polyurethane resin bears OH groups, the OH groups are preferably present on branched chains in terms of curing and durability properties, and such branch-borne OH groups are preferably present in a number of 2 to 40 per molecule, more preferably 3 to 20 per molecule. Such polar groups are present in a range of 10⁻¹ mol/g to 10⁻⁸ mol/g, preferably 10⁻² mol/g to 10⁻⁶ mol/g.

Specific examples of the binder may include, for example, VAGH, VYHH, VMCH, VAGF, VAGD, VROH, VYES, VYNC, VMCC, XYHL, XYSG, PKHH, PKHJ, PKHC and PKFE made by Union Carbide; MPR-TA, MPR-TA5, MPR-TAL, MPR-TSN, MPR-TMF, MPR-TS, MPR-TM and MPR-TAO made by Nissin Chemical Industry; 1000W, DX80, DX81, DX82, DX83 and 100FD made by Denki Kagaku Kogyo; MR-104, MR-105, MR110, MR100, MR555 and 400X-110A made by Zeon; Nipporan N2301, N2302, N2304 made by Nippon Polyurethane; Pandex T-5105, T-R3080, T-5201, Barnock D-400, D-210-80, Crisvon 6109 and 7209 made by Dainippon Ink and chemicals; Vylon UR8200, UR8300, UR8700, RV530 and RV280 made by Toyobo; Dipheramin 4020, 5020, 5100, 5300, 9020, 9022 and 7020 made by Dainichiseika; MX5004 made by Mitsubishi Chemical; Sanprene SP-150 made by Sanyo Chemical Industries; and Saran F310 and F210 made by Asahi Kasei.

The binder used in the inventive magnetic layer is added in a range of 5 mass % to 50 mass %, preferably 10 mass % to 30 mass %, based on the mass of the ferromagnetic powder (the ferromagnetic metal powder or the ferromagnetic hexagonal ferrite powder). If a polyurethane resin is used as the binder, 2 mass % to 20 mass % of the polyurethane resin is preferably combined with 2 mass % to 20 mass % of a polyisocyanate. In the case where slight dechlorination induces corrosion of the head, for instance, the polyurethane alone or a combination of the polyurethane and the polyisocyanate can be used without any other binder. Other resins include polyvinyl chloride resins which may be used in a range of 5 mass % to 30 mass %. The polyurethane resin used in the present invention preferably has a glass transition temperature of −50° C. to 150° C., preferably 0° C. to 100° C., elongation at break of 100% to 200%, rupture stress of 0.49 MPa to 98 MPa, and yield stress of 0.49 MPa to 98 MPa.

The magnetic recording medium used in the present invention comprises a nonmagnetic layer and at least one magnetic layer. Therefore, binder contents, the contents in the binder of a polyvinyl chloride resin, a polyurethane resin, polyisocyanate and/or other resins, the molecular weights and polar group contents of the respective resins forming the magnetic layer, the physical properties of the foregoing resins, or the like can be varied depending on the layer type, either magnetic or nonmagnetic, if necessary, and the respective layers should be rather optimized through such variations, which can be carried out by the known techniques of magnetic multilayers. As an example where the binder contents are varied in the layers, the binder content in the magnetic layer can be increased effectively to reduce the friction of the surface of the magnetic layer, or the binder content in the nonmagnetic layer can be increased to make it softer and thereby provide the magnetic recording medium with a better tough with the head.

The polyisocyanate available in the present invention may include, for example, isocyanates such as tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate and triphenylmethane triisocyanate; products of the isocyanates and polyalcohols; and polyisocyanates produced by condensation of the isocyanates. Commercial products of the isocyanates include Coronate L, Coronate HL, Coronate 2030, Coronate 2031 Millionate MR and Millionate MTL made by Nippon Polyurethane Industry; Takenate D-102, Takenate D-110N, Takenate D-200 and Takenate D-202 made by Takeda Chemical Industries; and Desmodule L, Desmodule IL, Desmodule N and Desmodule HL made by Sumitomo Bayer, where the isocyanates may used, in each layer, alone or in combination of two or more products taking advantage of differences in curability.

### V. Other Additives

The magnetic layer in the present invention may be loaded with additives, if necessary. The additives may include an abrasive material, a lubricant, a dispersant, a fungicide, an antistatic agent, an antioxidant, a solvent and carbon black.

Examples of the additives available here may include molybdenum disulfide, tungsten disulfide, graphite, boron nitride, fluorinated graphite, silicone oils, polar-group containing silicones, fatty acid-modified silicones, fluorinated silicones, fluorinated alcohols, fluorinated esters, polyolefins, polyglycols, polyphenyl ethers; organic aromatic ring-containing phosphonic acids such as phenyl phosphonic acid and alkali metal salts thereof; alkylphosphonic acids such as octylphosphonic acid and alkali metal salts thereof; aromatic phosphates such as phenyl phosphate and alkali metal salts thereof; alkyl phosphates such as octyl phosphate and alkali metal salts thereof; alkylsulfonate esters and alkali metal salts thereof; fluorinated alkyl sulfates and alkali metal salts thereof; monobasic fatty acids such as lauric acid, which have 10 to 24 carbon atoms and are optionally unsaturated and/or branched, and metal salts thereof; fatty acid monoesters, fatty acid diesters or fatty acid polyesters, such as butyl stearate, which are formed by combining a monobasic fatty acid optionally unsaturated and/or branched having 10 to 24 carbon atoms with a hydroxyl compound selected from a monohydric to hexahydric alcohol optionally unsaturated and/or branched having 12 to 22 carbon atoms, an alkoxyl alcohol or a monoalkyl ether of a alkylene oxide polymer optionally unsaturated and/or branched having 12 to 22 carbon atoms; fatty acid amides having 2 to 22 carbon atoms; and aliphtic amines having 8 to 22 carbon atoms. Furthermore, alkyl, aryl and aralkyl groups described above may be substituted with a non-hydrocarbon group(s), such as a nitro group and F, Cl, Br, and halogenated hydrocarbons (CCl₃, CBr₃). The additives available here may also include nonionic surfactants based on alkylene oxides, glycerol, glycidol, and alkylpheno/ethylene oxide adducts, respectively; cationic surfactants such as cyclic amines, esteramides, quaternary ammonium salts, hydantoin derivatives, heterocycles, phosphoniums and sulfoniums; anionic surfactants containing an acidic group(s) such as carboxylic acid, sulfonic acid and sulfate; and amphoteric surfactants such as amino acids, aminosulfonic acids, sulfates and phosphates of aminoalcohols, and alkyl betaines.

These surfactants are described in detail in “Surfactant Handbook” (published in Japanese by Sangyo Tosho Co, Ltd.). The additives may not be necessarily pure, but may contain impurities such as isomers, unreacted starting materials, byproducts, decomposition products, and oxidation products, in addition to main components. The impurities preferably have a content of 30 mass % or less, more preferably 10 mass % or less. Specific examples of the additives include, for example, NAA-102, castor oil-cured fatty acids, NAA-42, Cation SA, Nymeen L-201, Nonion E-208, Anone BF, Anone LG made by NOF Corporation; FAL-205 and FAL-123 made by Takemoto Oils & Fats; Enugelb OL made by New Japan Chemical; TA-3 made by Shinetsu Chemical; Armide P made by Lion Armer; Duomine TDO made by Lion; BA-41G made by Nisshin Oil Mills; and Prophane 2012E, Newpole PE61, and Ionet MS-400 made by Sanyo Chemical.

The magnetic layer and nonmagnetic layer in the present invention can be mixed with carbon black to lower the surface electric resistance as well as provide a desired Vickers microhardness. The inventive magnetic layer and nonmagnetic layer typically have a Vickers microhardness of 25 kg/mm² to 60 kg/mm², and preferably 30 kg/mm² to 50 kg/mm² to provide a proper tough of the magnetic recording medium with the head. It can be measured by a thin film hardness meter (HMA-400 manufactured by NEC) with a triangular pyramidal diamond needle as indenter tip which has a sharpness of 80° and a tip diameter of 0.1 μm. The carbon black available in the magnetic layer and nonmagnetic layer may include furnace black for rubber, thermal black for rubber, carbon black for color, and acetylene black.

The carbon black preferably has a specific surface of 5 m²/g to 500 m²/g, a DBP oil absorption of 10 mL/100 g to 400 mL/100 g, a particle size of 5 nm to 300 nm, a pH value of 2 to 10, a water content of 0.1% to 10%, and a tap density of 0.1 g/mL to 1 g/mL. Specific examples of the carbon black available in the inventive nonmagnetic layer include BLACKPEARLS 2000, 1300, 1000, 900, 905, 800 and 700, and VULCAN XC-72 made by Cabot; #80, #60, #55, #50 and #35 made by Asahi Carbon; #3050B, #3150B, #3250B, #3750B, #3950B, #2400B, #2300, #1000, #970B, #950, #900, #850B, #650B, #30, #40, #10B and MA-600 made by Mitsubishi Chemical Corporation; CONDUCTEX SC, RAVEN 8800, 8000, 7000, 5750, 5250, 3500, 2100, 2000, 1800, 1500, 1255, 1250, 150, 50, 40 and 15, RAVEN-MT-P made by Colombia Carbon; and Ketchen Black EC made by Akzo.

The carbon black may be surface-treated with a dispersant or the like, grafted with a resin before its use, or graphitized on a portion of the surface before its use. Furthermore, the carbon black may be dispersed in a binder before it is added into the magnetic coating medium. The carbon black may be used alone or in combination of different types. The carbon black is preferably used in a range of 0.1 mass % to 30 mass % based on the magnetic material. The carbon black is able, for example, to prevent charging of the magnetic layer, lower its friction coefficient, providing a light-shielding property, and increase its film strength, and its capabilities depend on the type used. Accordingly, the carbon black used in the present invention can be varied freely with respect to the type, the content and a combination of types, if any, in each of the magnetic and nonmagnetic layers to regulate the foregoing properties, such as particle size, oil absorption, electric conductivity and pH, according to the purpose, and each layer should be rather optimized for use of the carbon black by such variations. The carbon black available in the present invention can be referred, for example, to “Carbon Black Handbook” edited in Japanese by Carbon Black Society.

The organic solvent used in the present invention may be selected from known solvents. The organic solvent used in the present invention may be any ratio of solvents selected from the following solvents: ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; and N,N-dimethylformamide and hexane. The organic solvent may not be necessarily pure, but may contain impurities such as isomers, unreacted starting materials, byproducts, decomposition products, oxidation products and water, in addition to main components. The impurities preferably have a content of 30% or less, more preferably 10% or less. The type of the organic solvent used in the present invention is preferably common to the magnetic layer and the nonmagnetic layer. The amounts thereof to be added into the layers may be different. It is essentially important to coat the nonmagnetic layer more stably using a solvent with a high surface tension, specifically, setting the arithmetic average of a solvent composition for the nonmagnetic layer equal to or below the arithmetic average of a solvent composition for the upper layer. The solvent composition is preferably more polar to some extent in order to improve the dispersibility of the coating media, and preferably contains at least 50% of a solvent with a dielectric constant of 15 or more. In addition, the solvent composition preferably has a solubility parameter of 8 to 11.

The dispersant, lubricant and surfactant used in the present invention may be used in varying amounts with different types, if necessary, in the magnetic layer and/or the nonmagnetic layer. Although it applies without any limitation to the cases shown here, a dispersant, as an example, adsorbs or binds to a surface by its polar group, which surface is provided mainly by the surface of the ferromagnetic powder in the magnetic layer and by the surface of the nonmagnetic powder in the nonmagnetic layer, and once an organic phosphorus compound adsorbs to the surface, it would be difficult to desorb if the surface is of a metal, a metal compound or the like. As a consequence, the surface of the ferromagnetic powder (the ferromagnetic metal powder and ferromagnetic hexagonal ferrite powder) or the nonmagnetic powder would be covered with an alkyl group, an aromatic group or the like so that the ferromagnetic powder or the nonmagnetic powder may have a higher affinity to the binder, and thus that the ferromagnetic powder or the nonmagnetic powder may be dispersed more stably. As for the lubricant, it may be effectively used as follows: fatty acids with different melting points are used for the magnetic layer and the nonmagnetic layer, respectively, so that they are in a free form, in order to control their bleeding out of the surface; esters with different boiling points or polarities are used to control their bleeding out of the surface; the lubricant is used to adjust the content of the surfactant and thereby enhance the stability during coating; and a larger amount of the lubricant is added into the nonmagnetic layer to enhance lubrication. All or part of the additives used in the present invention may be added in any step of the process for producing a coating dispersion for the magnetic layer or the nonmagnetic layer. For instance, they may be added for mixing thereof with the ferromagnetic powder prior to the kneading step; in the kneading step for mixing the ferromagnetic powder, the binder and the solvent; in the dispersing step; after the dispersing steps; immediately before the coating step; or otherwise.

### VI. Back Coat Layer and Adhesion Promoting Layer

Generally, magnetic tapes for recording computer data are strongly required to have a higher repeated running property than video tapes and audio tapes. In order to have such a high repeated running property, a back coat layer may be provided on the back surface of the nonmagnetic support opposite to the surface thereof on which the magnetic layer and the nonmagnetic layer have been provided. A coating dispersion for the back coat layer contains an abrasive material, an antistatic agent and the like as well as a binder dispersed in an organic solvent. Various inorganic pigments and/or carbon black may be used as particulate component. The binder includes resins, for example, nitrocellulose, phenoxy resins, vinyl chloride-based resins, polyurethanes and the like, which may be used alone or in combination thereof.

The nonmagnetic support of the present invention may have a flattening layer and/or an adhesion promoting layer provided thereon, where the latter layer is provided for adhering the back coat layer thereto more strongly. The adhesion promoting layer is formed of any of the materials exemplified below that are soluble in the solvent. They are polyester resins, polyamide resins, polyamideimide resins, polyurethane resins, vinyl chloride-based resins, vinylidene chloride resins, phenol resins, epoxy resins, urea resins, melamine resins, formaldehyde resins, silicone resins, starch, modified starch compounds, alginate compounds, casein, gelatine, pullulane, dextran, chitin, chitosan, rubber latex, gum arabicum, gloiopeltis, natural rubber, dextrin, modified cellulose resins, polyvinyl alcohol resins, polyethylene oxide, polyacrylate resins, polyvinyl pyrrolidone, polyethylene imine, polyvinyl ether, polymaleic acid coplymers, polyacrylamide, alkyd resins and the like.

The adhesion promoting layer has a thickness of 0.01 μm to 3.0 μm without particular limitation, but preferably 0.02 μm to 2.0 μm, more preferably 0.05 μm to 1.5 μm. The resin used in the adhesion promoting layer preferably has a glass transition temperature of 30° C. to 120° C., more preferably 40° C. to 80° C. As long as it is 30° C. or more, blocking on the end face is not induced, while the glass transition temperature of 120° C. or less can relax internal stress in the adhesion promoting layer and also provide a superior adhesion.

### VII. Layers Configuration

The magnetic recording medium of the present invention has at least two coated layers on at least one surface of a nonmagnetic support, i.e., a nonmagnetic layer and a magnetic layer provided on the nonmagnetic layer, wherein the magnetic layer may comprise two or more layers, if necessary. It may also have a back coat layer provided on the opposite surface of the nonmagnetic support, if necessary. Additionally, the magnetic recording medium of the present invention may have a lubricant coating, various coatings for protecting the magnetic layer and/or the like provided on the magnetic layer, if necessary. Furthermore, an undercoat (adhesion promoting layer) may be provided between the nonmagnetic support and the nonmagnetic layer to provide a higher adhesion between the coated layer and the nonmagnetic support and/or the like.

The magnetic recording medium of the present invention may have a nonmagnetic layer and a magnetic layer on one surface of a nonmagnetic support, but have them on both surfaces thereof. After the nonmagnetic layer (lower layer) is coated, the magnetic layer (upper layer) may be coated while the lower layer is still wet or after it is dried. Simultaneous coating or stepwise coating onto wet surface is preferable in terms of production yield, but in the case of coating a disk, stepwise coating onto dried surface is quite useful. In the construction of the inventive multilayer configuration, the simultaneous coating or stepwise coating onto wet surface can form the upper layer/lower layer at the same time, which can be effectively used for surface processing such as calendering and thus improving the surface roughness of the upper magnetic layer even if it is very thin.

As for layer thicknesses in the magnetic recording medium used herein, the nonmagnetic support preferably has a thickness of 3 μm to 80 μm. If the nonmagnetic support is intended for computer tapes, it has a thickness of 3.5 μm to 7.5 μm, preferably 3 μm to 7 μm. If the undercoat is provided between the nonmagnetic support and the nonmagnetic layer or magnetic layer, the undercoat has a thickness of 0.01 μm to 0.8 μm, preferably 0.02 μm to 0.6 μm. The back coat layer has a thickness of 0.1 μm to 1.0 μm, and preferably 0.2 μm to 0.8 μm, wherein the back coat layer is provided on the back surface of the nonmagnetic support opposite to the surface on which the nonmagnetic layer and magnetic layer have been provided.

The thickness of the magnetic layer should be optimized depending on the saturation magnetization of a head used, the head gap length and the band of recording signals, but it is typically from 10 nm to 100 nm, preferably 20 nm to 80 nm, and more preferably 30 nm to 80 nm. The magnetic layer preferably has a degree of thickness variation of less than ±50%, more preferably less than ±40%. The magnetic layer may comprise only one layer, and two or more separated layers with different magnetic properties, which can follow known configurations of magnetic multilayers.

The nonmagnetic layer of the present invention has a thickness of 0.02 μm to 3.0 μm, preferably 0.05 μm to 2.5 μm, and more preferably 0.1 μm to 2.0 μm. It should be noted that the nonmagnetic layer of the magnetic recording medium of the present invention exhibit its effect if it is substantially nonmagnetic, and even if it contains a little amount of magnetic material as impurity or by intention, the resulting magnetic recording medium exhibits the inventive effect and can be considered to have substantially the same constitution as the inventive magnetic recording medium. Here, the expression “substantially the same” means that the nonmagnetic layer has a residual magnetic flux density of 10 T·m (100 G) or less or a coercive force of 7.96 kA/m (1.00 Oe) or less, preferably no residual magnetic flux density or coercive force.

### VIII. Physical Properties

The magnetic layer of the magnetic recording medium used in the invention has a residual magnetic flux density of 100 T·m to 300 T·m. The magnetic layer has Hc of 143.3 kA/m to 318.4 kA/m, preferably 159.2 kA/m to 278.6 kA/m. The coercive force preferably has a narrower distribution, both SFD and SFDr being 0.6 or less, more preferably 0.2 or less.

The magnetic recording medium used in the invention has a friction coefficient against the head of 0.5 or less, preferably 0.3 or less, under the conditions of temperature from −10 to 40° C. and humidity from 0 to 95%. It preferably has a specific surface resistance of 10⁴ to 10¹² Ω/sq on the magnetic surface and a charge potential of +500 V to −500 V. The magnetic layer has an elastic modulus at 0.5% elongation preferably ranging from 0.98 GPa to 19.6 GPa in all in-plane directions, and a rupture strength preferably ranging from 98 MPa to 686 MPa, while the magnetic recording medium has an elastic modulus preferably ranging from 0.98 GPa to 14.7 GPa in all in-plane directions, a residual elongation preferably of 0.5% or less, and a heat shrinkage at any temperature of 100° C. or lower, preferably, equal to or less than 1%, more preferably, equal to or less than 0.5%, and most preferably, equal to or less than 0.2%.

The magnetic layer preferably has a glass transition temperature (the maximal point of loss elastic muduli from dynamic viscoelastic measurements conducted at 110 Hz) of 50° C. to 180° C., while the nonmagnetic layer preferably has that of 0° C. to 180° C. It has a loss elastic mudulus preferably from 1×10⁷ to 8×10⁸ Pa, and a loss tangent preferably of 0.2 or less. If its loss tangent is too high, adhesion troubles happen more often. Preferably, these thermal and mechanical properties are substantially equal within 10% of variability in all in-plane directions.

The solvent remaining in the magnetic layer is preferably 100 mg/m² or less, more preferably 10 mg/m² or less. The coated layer, either nonmagnetic or magnetic, has a void fraction preferably of 30 vol % or less, more preferably 20 vol % or less. A lower void fraction is preferable to provide a higher output, but it may be better to keep it at a certain level according to the purpose. For instance, disk media where repeated operations are more important have often a higher void fraction to achieve a higher running durability.

It is preferable that the magnetic layer has a maximum peak height SRmax of 0.5 μm or less, a ten-point average roughness SRz of 0.3 μm or less, a center surface peak height SRp of 0.3 μm or less, a center surface valley depth SRv of 0.3 μm or less, a center surface area ratio SSr of 20% to 80%, and an average wavelength Sλa of 5 μm to 300 μm. These can be controlled easily by controlling the surface property of the support by the filler therein, the surface texture of a roll for calendering and the like. It preferably has a curl equal to or less than ±3 mm.

The magnetic recording medium of the present invention may have a difference in physical property between the nonmagnetic layer and the magnetic layer according to the purpose. For instance, the nonmagnetic layer may have a higher elastic modulus to improve the running durability, while the magnetic layer may have a lower elastic modulus than the nonmagnetic layer to provide the magnetic recording medium with a softer touch with the head.

### IX. Production Process

The process for producing a coating dispersion for the magnetic layer of the magnetic recording medium used in the present invention comprises at least a kneading step, a dispersing step and mixing steps before and after these steps, if necessary. The individual steps may be each divided into two or more steps. All the raw materials used in the present invention, such as ferromagnetic hexagonal ferrite powder or ferromagnetic metal powder, a nonmagnetic powder, a benzenesulfonate derivative, a π-electron conjugated conducting polymer, a binder, carbon black, an abrasive material, an antistatic agent, a lubricant, and a solvent, may be added at the start of, or during any step. In addition, individual raw materials may be added in portions in two or more steps. For instance, polyurethane may be introduced in portions in the kneading step, dispersing step, and mixing step for adjusting the viscosity after dispersion. To attain the purpose of the present invention, known conventional techniques can be used as a part of the process. In the kneading step, an apparatus with a strong kneading power is preferably used, such as an open kneader, continuous kneader, pressure kneader, or extruder. In a kneader, the magnetic powder or the nonmagnetic powder is combined with all or part of the binder (preferably, 30% or more of the total binder), and 100 mass parts of the magnetic material is kneaded with 15 to 500 mass parts of the binder. The kneading procedure is described in detail in Japanese Patent Application Laid-Open Nos. 1-106338 and 1-79274. A medium for the magnetic layer or a medium for the nonmagnetic layer may be dispersed using glass beads. Such glass beads are suitably zirconia beads, titania beads or steel beads which are a high density dispersion medium. The dispersion medium is optimized for particle size and packing ratio before it is used. A dispersing machine used here may be one of the known machines.

In the production process of the magnetic recording medium of the present invention, a magnetic coating medium is coated, for example, on the surface of the traveling nonmagnetic support so that a magnetic layer is formed at a predetermined thickness. In such coating, more than one magnetic coating medium may be coated layer after layer either stepwise or simultaneously, or a nonmagnetic coating medium and a magnetic coating medium may be coated layer after layer either stepwise or simultaneously. Coaters available for coating the magnetic coating medium or the nonmagnetic coating medium include an air doctor coater, a blade coater, a rod coater, an extrusion coater, an air knife coater, a squeeze coater, an impregnation coater, a reverse roll coater, a transfer roll coater, a gravure coater, a kiss coater, a cast coater, a spray coater, and a spin coater. These coaters can be referred, for example, to “Advanced Coating Technology” (May 31, 1983) published in Japanese by Sogo Gijutsu Center Co., Ltd.

For magnetic tapes, in the coated layer of the magnetic coating medium, the ferromagnetic powder contained in the coated layer of the magnetic coating medium is magnetically oriented in a longitudinal direction by cobalt magnets or solenoids. For disks, the ferromagnetic powder may be oriented well isotropically without any treatment of orientation made by an orientation system, but a preferable treatment of orientation is made using a random orientation system as follows: by disposing cobalt magnets obliquely and alternately; by applying an alternate magnetic field with solenoids; or otherwise. Generally, the isotropic orientation of a fine ferromagnetic metal powder is preferably two-dimensional in-plane random orientation, but it may be three-dimensional random orientation made by addition of a vertical component. The hexagonal ferrite generally tends to take three-dimensional random orientation together with a vertical component, but it can also take two-dimensional in-plane random orientation. It can be also oriented vertically by a known method using opposite poles-facing magnets or the like to produce a radially isotropic magnetic property. Vertical orientation is especially favorable for high density recording. Additionally, spin coating can be used to produce radial orientation.

The coated layer is preferably dried at a proper position which can be located by controlling the temperature and flow rate of the drying air and the coating speed, and it is preferable that the coating speed is 20 ml/min to 1,000 m/min and the temperature of the drying air is 60° C. or higher. The coated layer may be dried preliminarily and appropriately before it enters into the magnet zone.

The coated layer undergoes surface flattening treatment after it is dried. The surface flattening treatment is carried out, for example, by a supercalender roll or the like. The surface flattening treatment is effective to eliminate voids formed by removal of the solvent in the drying and thus increase the filling rate of the ferromagnetic powder in the magnetic layer, leading to the production of a magnetic recording medium with a high electromagnetic conversion property The calendering roll used here is a heat-resistant plastic roll from epoxy, polyimide, polyamide, polyamideimide or the like. It may be a metal roll. Preferably, the magnetic recording medium of the present invention has extremely flat surfaces. For that purpose, a specific ferromagnetic powder and a binder are selected, for example as described above, to form a magnetic layer, which is then calendered as described above. The calendering is operated in a temperature range of the calender roll from 60° C. to 100° C., preferably from 70° C. to 100° C., and particularly preferably from 80° C. to 100° C., and in a line pressure range of 98 kN/m to 490 kN/m, preferably 196 kN/m to 441 kN/m, and particularly preferably 294 kN/m to 392 kN/m.

Reduction of the heat shrinkage can be attained by the following two processes wherein: the resultant magnetic tape is treated by heat in the form of a web while it is handled under low tension; and the tape is treated by heat in the form of a multilayer such as a bulk form or a cassette form into which the tape is incorporated (thermoprocessing). Thermoprocessing is more favorable in terms of high output and low noise of the magnetic recording medium to be provided.

The magnetic recording medium thus obtained is cut into a desired size with a cutter or the like before it is used.

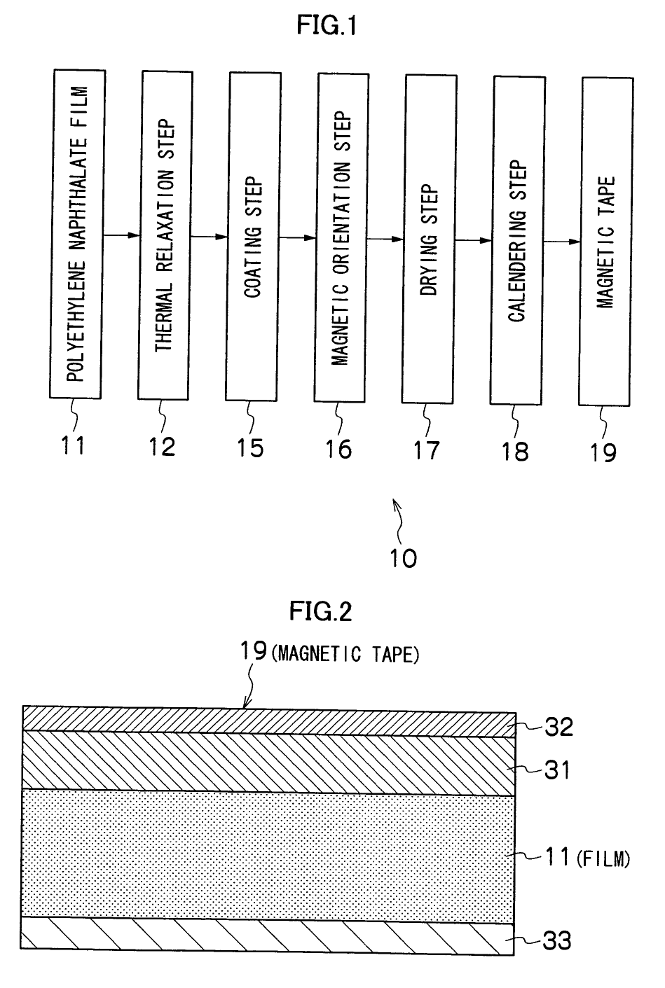

FIG. 1 illustrates a production process 10 to describe the method of producing a magnetic recording medium according to the present invention. A polyethylene naphthalate film (hereinafter, referred to as a film) 11 is used as the foregoing nonmagnetic support. The film 11 is subjected to a thermal relaxation step 12. In the thermal relaxation step 12, the film 11 is kept in a range of temperature 1° C. to 40° C. lower than the glass transition temperature of polyethylene naphthalate which is 125° C., i.e., equal to or more than 85° C. and equal to or less than 124° C. The time of thermal relaxation is set in a range of time equal to or more than 1 hour and equal to or less than 14 days. Then, the film 11 is subjected to a coating step 15 to form a nonmagnetic layer and a magnetic layer in this order thereon, where the respective coating media are coated. In the coating step 15, the nonmagnetic coating medium and the magnetic coating medium may be coated at the same time or stepwise.

A subsequent magnetic orientation step 16 is preferably carried out while the coated medium is still wet, since the wet state facilitates orientation. The magnetic field is preferably in a range equal to or more than 0.1 T·m and equal to or less than 1.0 T·m. In a drying step 17, the respective coating media are dried. Thereafter, the film 11 having the formed layers is preferably calendered in a calendering step 18 to produce a magnetic tape 19 as magnetic recording medium. The calendering step 18 can be carried out to provide the magnetic tape 19 having its surfaces smoothened.

In the production process 10 of the present invention, however, all the steps 12 to 18 are not always necessary to be carried out, but some of them may be optionally omitted. An additional step may be conducted. For instance, in any of the inventive steps, a back coat is preferably provided on the surface of the film 11 opposite to the surface on which the magnetic layer and the like are formed in order to improve the handling property of the magnetic tape 19.

In the present invention, the thermal relaxation step 12 is not necessarily conducted only before the layers are formed. After at least one of the nonmagnetic layer, the magnetic layer and the back coat is formed, the thermal relaxation step 12 may be conducted for each layer.

FIG. 2 shows a schematic sectional view of a magnetic tape which is an example of the magnetic recording medium according to the present invention. The nonmagnetic layer 31 and the magnetic layer 32 are formed on a surface of the film 11 which has been thermally relaxed. Also, a back coat layer 33 is formed on the surface of the film 11 opposite to the surface on which the layers 31, 32 are formed.

The present invention will be specifically described below in reference to Examples 1 and 2. Components, compositions, operations, sequences and the like given here may be varied unless they are out of the spirit of the present invention, and should not be limited to the Examples below. In the Examples, the term “parts” represents mass parts unless otherwise specified.

### EXAMPLE 1

### [Experiment 1]

1. Preparation of a magnetic coating medium

| | | |
|---|---|---|
| <Ferromagnetic needle metal powder> | 100 | parts |
| Composition: Fe/Co/Al/Y = 68/20/7/5, Surface treatment | | |
| agent: Al₂O₃, Y₂O₃ | | |
| Crystallite size: 125 Å, Long axial length: 45 nm, | | |
| Needle's length/width ratio: 5, | | |
| Specific surface by BET: 42 m²/g | | |
| Coercive force (Hc): 180 kA/m | | |
| Saturation magnetization (σs): 135 A · m²/kg | | |
| <Polyurethane resin> | 12 | parts |
| Branched polyester polyol/diphenylmethane | | |
| diisocyanate system | | |
| Hydrophilic polar group: —SO₃Na (a content of 70 eq/ton) | | |
| Phenylphosphonic acid | 3 | parts |
| α-Al₂O₃ (particle size: 0.1 μm) | 2 | parts |
| Carbon black (particle size: 20 nm) | 2 | parts |
| Cyclohexanone | 110 | parts |
| Methyl ethyl ketone | 100 | parts |
| Toluene | 100 | parts |
| Butyl stearate | 2 | parts |
| Stearic acid | 1 | part |

2. Preparation of a nonmagnetic coating medium

| | | |
|---|---|---|
| <Nonmagnetic inorganic powder> | 85 | parts |
| α-iron oxide, Surface treatment agent: Al₂O₃, SiO₂ | | |
| Long axial length: 0.15 μm, Needle's length/width ratio: 7, | | |
| Specific surface by BET: 50 m²/g | | |
| DBP oil absorption: 33 g/100 g at pH 8 | | |
| <Carbon black> | 20 | parts |
| Specific surface by BET: 250 m²/g, DBP | | |
| oil absorption: 120 mL/100 g at pH 8, | | |
| Volatiles: 1.5% | | |
| <Polyurethane resin> | 12 | parts |
| Branched polyester polyol/diphenylmethane | | |
| diisocyanate system | | |
| Hydrophilic polar group: —SO₃Na (70 eq/ton) | | |
| <Acryl resin> | 6 | parts |
| Benzyl methacrylate/diacetone acrylamide system | | |
| Hydrophilic polar group: —SO₃Na (60 eq/ton) | | |
| Phenylphosphonic acid | 3 | parts |
| α-Al₂O₃ (average particle size: 0.2 μm) | 1 | part |
| Cyclohexanone | 140 | parts |
| Methyl ethyl ketone | 170 | parts |
| Butyl stearate | 2 | parts |
| Stearic acid | 1 | part |

To prepare the coating composition for a magnetic layer (upper layer) and the coating composition for a nonmagnetic layer (lower layer), respectively, the components were kneaded in an open kneader for 60 minutes, and then dispersed in a sand mill for 120 minutes. The resulting dispersion was loaded with 6 parts of a trifunctional low-molecular-weight polyisocyanate compound (Coronate 3041 made by Nippon Polyurethane) and mixed with stirring for 20 minutes, and then filtrated through a filter having an average pore size of 1 μm to prepare the magnetic coating medium and the nonmagnetic coating medium.

A polyethylene naphthalate (PEN) film (Tg=125° C.) 11 with a thickness of 5 μm, a surface roughness of 3 nm of a surface for forming a magnetic layer, and a surface roughness of 8 nm of a back surface was heated in a processing system having a heating zone at 120° C., rolled and then stored in the roll form in the processing system at 110° C. for one week to progress relaxation (thermal relaxation step 12). An enthalpy relaxation after the storage was 1.8 J/g as measured by DSC.

Next, the nonmagnetic coating medium was coated on the film to provide a dry coat thickness of 1.8 μm, and immediately after that, the magnetic coating medium was coated thereon in a simultaneous multilayering manner to provide a dry coat thickness of 0.1 μm (coating step 15). Then, both coated layers were magnetically oriented with 300-T·m magnets while they were still wet (magnetic orientation step 16), and dried (drying step 17). Thereafter, the resulting coated film was processed using a 7-stage calender composed of only metal rolls at a temperature of 90° C., a rate of 100 m/min, and a line pressure of 300 kgf/cm (calendering step 18), treated by heat at 70° C. for 48 hours, and slit into a half-inch width to produce magnetic tape 19.

### [Experiments 2 to 10]

In Experiments 2 to 10, magnetic tape was produced in the same manner as in Experiment 1 except that the temperature and time for heat treatment (thermal relaxation step 11) of the nonmagnetic support, and the long axial length of the magnetic material were varied.

### <Measurement Method>

### 1. Measurement of Enthalpy Relaxation (ΔH)

A portion of the polyethylene naphthalate film weighing 10 mg was subjected to DSC using a DSC Q100 manufactured by TA Instruments at a temperature rise rate of 5° C./min, a temperature modulation cycle of 30 seconds, and a temperature modulation amplitude of 0.5° C. In the nonreversible heat flow thus measured, the peak area around the Tg was determined as the enthalpy relaxation (ΔH).

### 2. Measurement of Error Rates (in Initial Period, and at Elevated Temperature and Humidity)

Signals were recorded on the magnetic tapes produced in the Experiments by the 8-10 conversion PR1 equalization method at 23° C. and 50% RH, and the recorded magnetic tapes were measured for error rate under the respective environments of 23° C. and 50% RH, and of 40° C. and 80% RH.

The results of the measurements are shown in Table 1.

TABLE 1

| | Nonmagnetic support (PEN) | | Magnetic | | | |
|---|---|---|---|---|---|---|
| | (Thickness 5.0 μm) | | material | Enthalpy | Error rate | |
| | Heat treatment | Heat treatment | (iron alloy) | relaxation | | 40° C. |
| | temperature | time | Plate size | ΔH | | 80% RH |
| | ° C. | Hr | nm | J/g | Initial × 10⁻⁵ | ×10⁻⁵ |
| Experiment 1 | 110 | 168 | 45 | 1.9 | 0.18 | 1.12 |
| Experiment 2 | 110 | 96 | 45 | 1.5 | 0.16 | 1.35 |
| Experiment 3 | 100 | 48 | 45 | 1.0 | 0.15 | 0.99 |
| Experiment 4 | 90 | 24 | 45 | 0.6 | 0.13 | 1.17 |
| Experiment 5 | nil | nil | 45 | 0.0 | 0.18 | 11.69 |
| Experiment 6 | 100 | 5 | 45 | 0.4 | 0.20 | 10.89 |
| Experiment 7 | 100 | 5 | 70 | 0.4 | 1.56 | 8.98 |
| Experiment 8 | 100 | 48 | 70 | 1.0 | 1.69 | 7.23 |

As is clear from the results shown in Table 1, a nonmagnetic support with a large increase in enthalpy relaxation (ΔH) gives a less increase of error rate relative to the initial error rate even after it is stored under the elevated temperature and humidity environment of 40° C. and 80% RH. For instance, it has been found out that the support in Experiment 5 which has an enthalpy relaxation (ΔH) of 0.01 J/g due to no heat treatment has an error rate increase of 11.59×10⁻⁵, while the support in Experiment 1 which has an enthalpy relaxation (ΔH) as much as 1.9 J/g has an error rate increase of 0.94×10⁻⁵.

Additionally, an error rate increase given by an enthalpy relaxation (ΔH) slightly below 0.5 J/g, as in Experiment 6 or 7, is in the order of b 10.69×10⁻⁵ to 7.42×10⁻⁵, much larger than an error rate increase of 1.04×10⁻⁵ shown in Experiment 4 and given by an enthalpy relaxation (ΔH) slightly above 0.5 J/g. Consequently, a biaxially oriented film having an enthalpy relaxation (ΔH) below 0.5 J/g is greatly out of equilibrium in the glass state and thus has too low a dimensional stability to be used as nonmagnetic support for magnetic recording media. Although not shown in Table 1, more than 2.0 J/g of enthalpy relaxation (ΔH) has been also found to cause the problems of reducing the orientation of the support once enhanced by drawing and the like.

Furthermore, a comparison between the cases giving different plate sizes of the magnetic material, 45 nm (Experiment 3) and 70 nm (Experiment 8), respectively, but the same enthalpy relaxation (ΔH) of 1.0 J/g has demonstrated a much larger error rate increase of Experiment 8 giving a larger plate size.

### EXAMPLE 2

### [Experiments 9 to 16]

1. Preparation of a magnetic coating medium

| | | |
|---|---|---|
| <Ferromagnetic plate hexagonal ferrite powder> | 100 | parts |
| Composition (molar ratio): Ba/Fe/Co/Zn = 1/9/0.2/0.8 | | |
| Plate size: 30 nm, Plate's length/width ratio: 3, | | |
| Specific surface by BET: 50 m²/g | | |
| Coercive force (Hc): 191 kA/m | | |
| Saturation magnetization (σs): 60 A · m²/kg | | |
| <Polyurethane resin> | 12 | parts |
| Branched polyester polyol/diphenylmethane | | |
| diisocyanate system | | |
| Hydrophilic polar group: —SO₃Na (a content of 70 eq/ton) | | |
| Phenylphosphonic acid | 3 | parts |
| α-Al₂O₃ (particle size: 0.15 μm) | 2 | parts |
| Carbon black (particle size: 20 nm) | 2 | parts |
| Cyclohexanone | 110 | parts |
| Methyl ethyl ketone | 100 | parts |
| Toluene | 100 | parts |
| Butyl stearate | 2 | parts |
| Stearic acid | 1 | part |

Experiment 9 was carried out under the same conditions as in Example 1 except that the magnetic coating medium contained barium ferrite instead. The experimental conditions are shown in Table 2. Experiments 10 and 16 were carried out in the same way as Experiment 11 to produce magnetic tape except that the temperature and time for heat treatment (thermal relaxation step 11) of the nonmagnetic support (i.e., polyethylene naphthalate film) 11, and the long axial length of the magnetic material were varied as shown in Table 2. Individual measurements were conducted under the same conditions as in Example 1. All the results of measurements are shown in Table 2.

TABLE 2

| | Nonmagnetic support | | Magnetic | | | |
|---|---|---|---|---|---|---|
| | (PEN) | | material | | | |
| | (Thickness 5 μm) | | (barium | Enthalpy | Error rate | |
| | Heat treatment | Heat treatment | ferrite) | relaxation | | 40° C. |
| | temperature | time | Plate size | ΔH | | 80% RH |
| | ° C. | Hr | nm | J/g | Initial × 10⁻⁵ | ×10⁻⁵ |
| Experiment 9 | 110 | 168 | 25 | 1.9 | 0.13 | 0.85 |
| Experiment 10 | 110 | 96 | 25 | 1.5 | 0.15 | 0.67 |
| Experiment 11 | 100 | 48 | 25 | 1.0 | 0.13 | 0.51 |
| Experiment 12 | 90 | 24 | 25 | 0.6 | 0.11 | 0.65 |
| Experiment 13 | nil | nil | 25 | 0.0 | 0.14 | 6.89 |
| Experiment 14 | 100 | 5 | 25 | 0.4 | 0.13 | 8.26 |
| Experiment 15 | 100 | 5 | 50 | 0.4 | 2.35 | 8.97 |
| Experiment 16 | 100 | 48 | 50 | 1.0 | 1.98 | 9.65 |

As is clear from the results shown in Table 2, a nonmagnetic support with a large increase in enthalpy relaxation (ΔH) gives a less increase of error rate relative to the initial error rate even after it is stored under the elevated temperature and humidity environment of 40° C. and 80% RH, which indicates that the results on barium ferrite used as magnetic material are similar to those on iron alloy used also as magnetic material in Example 1. For instance, it has been found out that the support in Experiment 13 which has an enthalpy relaxation (ΔH) of 0.01 J/g due to no heat treatment has an error rate increase of 6.75×10⁻⁵, while the support in Experiment 9 which has an enthalpy relaxation (ΔH) as much as 1.9 J/g has an error rate increase of 0.72×10⁻⁵.

Additionally, an error rate increase given by an enthalpy relaxation (ΔH) slightly below 0.5 J/g, as in Experiment 14 or 15, is in the order of 8.13×10⁻⁵ to 6.62×10⁻⁵, much larger than an error rate increase of 1.04×10⁻⁵ shown in Experiment 12 and given by an enthalpy relaxation (ΔH) slightly above 0.5 J/g. Consequently, a biaxially oriented film having an enthalpy relaxation (ΔH) below 0.5 J/g is greatly out of equilibrium in the glass state and thus has too low a dimensional stability to be used as nonmagnetic support for magnetic recording media. Although not shown in Table 2, more than 2.0 J/g of enthalpy relaxation (ΔH) has been also found to cause the problems of reducing the orientation of the support once enhanced by drawing and the like.

Furthermore, a comparison between the cases giving different plate sizes of the magnetic material, 25 nm (Experiment 11) and 50 nm (Experiment 16), respectively, but the same enthalpy relaxation (ΔH) of 1.0 J/g has demonstrated a much larger error rate increase of Experiment 16 giving a larger plate size.

As for the plate size of magnetic materials, the error rate increase was tested for the magnetic materials having different plate sizes from about 1 nm to about 90 nm, in addition to the results shown in Tables 1 and 2. As a result, the plate size has been found to be in a range, preferably, equal to or more than 5 nm and equal to or less than 40 nm.

What is claimed is:

1. A magnetic recording medium comprising following layers in this order on at least one surface of a nonmagnetic support:
a nonmagnetic layer including a nonmagnetic powder and a binder; and
a magnetic layer including a magnetic powder and a binder, wherein the nonmagnetic support has an enthalpy relaxation (ΔH) equal to or more than 0.5 J/g and equal to or less than 2.0 J/g.

2. The magnetic recording medium according to claim 1, wherein the magnetic powder is one of a ferromagnetic hexagonal ferrite powder having an average plate size equal to or more than 5 nm and equal to or less than 40 nm and a fine ferromagnetic metal powder having an axial length as average length equal to or more than 20 nm and equal to or less than 60 nm.

3. A method of producing a magnetic recording medium having a nonmagnetic layer including a nonmagnetic powder and a binder and a magnetic layer including a magnetic powder and a binder in this order on at least one surface of a nonmagnetic support, the method comprising:
a thermal relaxation step of allowing the nonmagnetic support to have an enthalpy relaxation (ΔH) equal to or more than 0.5 J/g and equal to or less than 2.0 J/g.

4. The method of producing a magnetic recording medium according to claim 3, wherein the magnetic powder used in the method is one of a ferromagnetic hexagonal ferrite powder having an average plate size equal to or more than 5 nm and equal to or less than 40 nm and a fine ferromagnetic metal powder having an axial length as average length equal to or more than 20 nm and equal to or less than 60 nm.

5. The method of producing a magnetic recording medium according to claim 3, wherein in the thermal relaxation step, the nonmagnetic support is kept in a temperature range equal to or more than Tg (° C.) −40° C. and equal to or less than Tg (° C.) −1° C., and wherein said Tg (° C.) represents the glass transition temperature of a resin forming the nonmagnetic support.

6. The method of producing a magnetic recording medium according to claim 4,
wherein in the thermal relaxation step, the nonmagnetic support is kept in a temperature range equal to or more than Tg (° C.) −40° C. and equal to or less than Tg (° C.) −1° C., and
wherein said Tg (° C.) represents the glass transition temperature of a resin forming the nonmagnetic support.

7. The method of producing a magnetic recording medium according to claim 3, wherein the thermal relaxation step has a period of time equal to or more than 1 hour and equal to or less than 14 days.

8. The method of producing a magnetic recording medium according to claim 6, wherein the thermal relaxation step has a period of time equal to or more than 1 hour and equal to or less than 14 days.

9. The method of producing a magnetic recording medium according to claim 3, wherein the thermal relaxation step is carried out before at least one of the nonmagnetic layer and the magnetic layer is formed.

10. The method of producing a magnetic recording medium according to claim 4, wherein the thermal relaxation step is carried out before at least one of the nonmagnetic layer and the magnetic layer is formed.

11. The method of producing a magnetic recording medium according to claim 5, wherein the thermal relaxation step is carried out before at least one of the nonmagnetic layer and the magnetic layer is formed.

12. The method of producing a magnetic recording medium according to claim 6, wherein the thermal relaxation step is carried out before at least one of the nonmagnetic layer and the magnetic layer is formed.

13. The method of producing a magnetic recording medium according to claim 8, wherein the thermal relaxation step is carried out before at least one of the nonmagnetic layer and the magnetic layer is formed.

14. The method of producing a magnetic recording medium according to claim 3, wherein the nonmagnetic support is formed of one of biaxially oriented polyethylene terephthalate and biaxially oriented polyethylene naphthalate as main component.

15. The method of producing a magnetic recording medium according to claim 4, wherein the nonmagnetic support is formed of one of biaxially oriented polyethylene terephthalate and biaxially oriented polyethylene naphthalate as main component.

16. The method of producing a magnetic recording medium according to claim 5, wherein the nonmagnetic support is formed of one of biaxially oriented polyethylene terephthalate and biaxially oriented polyethylene naphthalate as main component.

17. The method of producing a magnetic recording medium according to claim 7, wherein the nonmagnetic support is formed of one of biaxially oriented polyethylene terephthalate and biaxially oriented polyethylene naphthalate as main component.

18. The method of producing a magnetic recording medium according to claim 9, wherein the nonmagnetic support is formed of one of biaxially oriented polyethylene terephthalate and biaxially oriented polyethylene naphthalate as main component.

19. The method of producing a magnetic recording medium according to claim 13, wherein the nonmagnetic support is formed of one of biaxially oriented polyethylene terephthalate and biaxially oriented polyethylene naphthalate as main component.
